(19) United States
(12) Patent Application Publication
(10) Pub. No.: US 2021/0019754 A1
(43) Pub. Date: Jan. 21, 2021

(54) Method, System, and Computer Program Product for Detecting Fraudulent Activity

(71) Applicant: Visa International Service Association, San Francisco, CA (US)

(72) Inventor: Ravi Krishnan Muthukrishnan, Austin, TX (US)

(21) Appl. No.: 16/516,981

(22) Filed: Jul. 19, 2019

(51) Int. Cl. G06Q 20/40; G06F 21/60; G06Q 50/00

(52) U.S. Cl. CPC G06Q 20/4016; G06Q 50/01; G06F 21/602

(57) ABSTRACT

A method for detecting fraudulent activity includes: generating a fraud control rule associated with a payment account parameter of a payment account; receiving a request message from a user device, where the request message includes social media data associated with a social media account of a user, where the social media data includes unencrypted social media data and encrypted social media data; analyzing the request message for fraudulent activity by analyzing the social media data with respect to the fraud control rule; automatically generating a response message including at least one of: a processing request message associated with the request message in response to the social media data not satisfying the fraud control rule; and a rejection message in response to the social media data satisfying the fraud control rule; and communicating the response message.

### BACKGROUND

### 1. Technical Field

The disclosure relates to preventing fraud and, in some non-limiting embodiments or aspects, to methods, systems, and computer program products for detecting fraudulent activity.

### 2. Technical Considerations

As part of a payment transaction, a transaction processing system may monitor certain parameters that may be indicative of a potentially fraudulent electronic payment transaction based on fraud control rules. Fraud control rules may be employed during card-not-present (CNP) electronic payment transactions, such as CNP credit and debit card transactions, based on certain specific fraud detection parameters, such as primary account number (PAN), an identifier of a device (e.g., a device identifier, an IP address of a device, and/or the like) involved in the electronic payment transaction, and/or bank identification number (BIN), to detect potentially fraudulent transactions.

Social payments may be electronic payment transaction that are initiated over a social media platform and may be executed via a client application running as a chatbot on the social media platform. However, transaction processing systems implementing fraud control rules may not be effective for detecting fraudulent activity during processing of social payments that initiated on social media platforms, such as Facebook®, WhatsApp®, Twitter®, and/or the like. For example, a transaction processing system implementing fraud control rules may not be able to obtain fraud detection parameters for the fraud control rules during processing of social payments. In such an example, the transaction processing system may not be able to perform checks (e.g., account level checks) on an account involved in the social payment.

### SUMMARY

Accordingly, and generally, provided is an improved method, system, and computer program product for detecting fraudulent activity.

According to some non-limiting embodiments or aspects, a method for detecting fraudulent activity includes: generating, with at least one processor, at least one fraud control rule associated with at least one payment account parameter of a payment account; receiving, with at least one processor, a request message from a user device, where the request message includes social media data associated with a social media account of a user, where the social media data includes unencrypted social media data and encrypted social media data; analyzing, with at least one processor, the request message for fraudulent activity by analyzing the social media data with respect to the at least one fraud control rule; automatically generating, with at least one processor, a response message, the response message including at least one of: a processing request message associated with the request message in response to the social media data not satisfying the fraud control rule; and (2) a rejection message in response to the social media data satisfying the fraud control rule; and communicating, with at least one processor, the response message.

In some non-limiting embodiments or aspects, analyzing the social media data with respect to the at least one fraud control rule may include: determining that the social media data corresponds to stored social media data; based on determining that the social media data corresponds to stored social media data, associating the social media data with the payment account; and determining whether the fraud control rule is satisfied. The stored social media data may be stored in a transaction service provider database or an issuer database. The method may further include generating, with at least one processor, update data associated with the at least one payment account parameter in response to receiving the request message. The at least one fraud control rule may include a velocity control rule including a count and defining a count limit associated with processing request messages associated with the payment account, where generating the update data associated with the at least one payment account parameter in response to receiving the request message includes incrementing the count. The request message may include at least one of: a payment transaction request message, an account validation inquiry request message, a balance inquiry request message, a fund transfer request message, and a payment device enrollment request message. Analyzing the social media data with respect to the at least one fraud control rule may include analyzing the encrypted social media data without decrypting the encrypted social media data. The encrypted social media data may be homomorphically encrypted. The request message may include a public key. The method may further include: in response to the social media data satisfying the fraud control rule, generating and communicating, with at least one processor, a fraud alert message. The request message may not include an account identifier associated with the payment account and assigned by an issuer system.

According to some non-limiting embodiments or aspects, a system for detecting fraudulent activity includes at least one processor programmed or configured to: generate at least one fraud control rule associated with at least one payment account parameter of a payment account; receive a request message from a user device, where the request message includes social media data associated with a social media account of a user, where the social media data includes unencrypted social media data and encrypted social media data; analyze the request message for fraudulent activity by analyzing the social media data with respect to the at least one fraud control rule; automatically generate a response message, the response message including at least one of: a processing request message associated with the request message in response to the social media data not satisfying the fraud control rule; and (2) a rejection message in response to the social media data satisfying the fraud control rule; and communicate the response message.

In some non-limiting embodiments or aspects, analyzing the social media data with respect to the at least one fraud control rule may include: determining that the social media data corresponds to stored social media data; based on determining that the social media data corresponds to stored social media data, associating the social media data with the payment account; and determining whether the fraud control rule is satisfied. The stored social media data may be stored in a transaction service provider database or an issuer database. The at least one processor may be further programmed or configured to: generate update data associated with the at least one payment account parameter in response to receiving the request message. The at least one fraud control rule may include a velocity control rule including a count and defining a count limit associated with processing request messages associated with the payment account, where generating the update data associated with the at least one payment account parameter in response to receiving the request message includes incrementing the count. The request message may include at least one of: a payment transaction request message, an account validation inquiry request message, a balance inquiry request message, a fund transfer request message, and a payment device enrollment request message. Analyzing the social media data with respect to the at least one fraud control rule may include analyzing the encrypted social media data without decrypting the encrypted social media data. The encrypted social media data may be homomorphically encrypted. The request message may include a public key. In response to the social media data satisfying the fraud control rule, the at least one processor may be further programmed or configured to generate and communicate a fraud alert message. The request message may not include an account identifier associated with the payment account and assigned by an issuer system.

According to some non-limiting embodiments or aspects, a computer program product for detecting fraudulent activity may include at least one non-transitory computer-readable medium including one or more instructions that, when executed by the at least one processor, cause the at least one processor to: generate at least one fraud control rule associated with at least one payment account parameter of a payment account; receive a request message from a user device, where the request message includes social media data associated with a social media account of a user, where the social media data includes unencrypted social media data and encrypted social media data; analyze the request message for fraudulent activity by analyzing the social media data with respect to the at least one fraud control rule; automatically generate a response message, the response message including at least one of: a processing request message associated with the request message in response to the social media data not satisfying the fraud control rule; and (2) a rejection message in response to the social media data satisfying the fraud control rule; and communicate the response message.

In some non-limiting embodiments or aspects, analyzing the social media data with respect to the at least one fraud control rule may include: determining that the social media data corresponds to stored social media data; based on determining that the social media data corresponds to stored social media data, associating the social media data with the payment account; and determining whether the fraud control rule is satisfied. The stored social media data may be stored in a transaction service provider database or an issuer database. The one or more instructions may cause the at least one processor to: generate update data associated with the at least one payment account parameter in response to receiving the request message. The at least one fraud control rule may include a velocity control rule including a count and defining a count limit associated with processing request messages associated with the payment account, where generating the update data associated with the at least one payment account parameter in response to receiving the request message includes incrementing the count. The request message may include at least one of: a payment transaction request message, an account validation inquiry request message, a balance inquiry request message, a fund transfer request message, and a payment device enrollment request message. Analyzing the social media data with respect to the at least one fraud control rule may include analyzing the encrypted social media data without decrypting the encrypted social media data. The encrypted social media data may be homomorphically encrypted. The request message may include a public key. In response to the social media data satisfying the fraud control rule, the one or more instructions may cause the at least one processor to generate and communicate a fraud alert message. The request message may not include an account identifier associated with the payment account and assigned by an issuer system.

Further non-limiting embodiments or aspects are set forth in the following numbered clauses:

Clause 1: A method for detecting fraudulent activity, comprising: generating, with at least one processor, at least one fraud control rule associated with at least one payment account parameter of a payment account; receiving, with at least one processor, a request message from a user device, wherein the request message comprises social media data associated with a social media account of a user, wherein the social media data comprises unencrypted social media data and encrypted social media data; analyzing, with at least one processor, the request message for fraudulent activity by analyzing the social media data with respect to the at least one fraud control rule; automatically generating, with at least one processor, a response message, the response message comprising at least one of: a processing request message associated with the request message in response to the social media data not satisfying the fraud control rule; and a rejection message in response to the social media data satisfying the fraud control rule; and communicating, with at least one processor, the response message.

Clause 2: The method of clause 1, wherein analyzing the social media data with respect to the at least one fraud control rule comprises: determining that the social media data corresponds to stored social media data; based on determining that the social media data corresponds to stored social media data, associating the social media data with the payment account; and determining whether the fraud control rule is satisfied.

Clause 3: The method of clause 1 or 2, wherein the stored social media data is stored in a transaction service provider database or an issuer database.

Clause 4: The method of any of clauses 1-3, further comprising: generating, with at least one processor, update data associated with the at least one payment account parameter in response to receiving the request message.

Clause 5: The method of any of clauses 1-4, wherein the at least one fraud control rule comprises a velocity control rule comprising a count and defining a count limit associated with processing request messages associated with the payment account, wherein generating the update data associated with the at least one payment account parameter in response to receiving the request message comprises incrementing the count.

Clause 6: The method of any of clauses 1-5, wherein the request message comprises at least one of: a payment transaction request message, an account validation inquiry request message, a balance inquiry request message, a fund transfer request message, and a payment device enrollment request message.

Clause 7: The method of any of clauses 1-6, wherein analyzing the social media data with respect to the at least one fraud control rule comprises analyzing the encrypted social media data without decrypting the encrypted social media data.

Clause 8: The method of any of clauses 1-7, wherein the encrypted social media data is homomorphically encrypted.

Clause 9: The method of any of clauses 1-8, wherein the request message comprises a public key.

Clause 10: The method of any of clauses 1-9, further comprising: in response to the social media data satisfying the fraud control rule, generating and communicating, with at least one processor, a fraud alert message.

Clause 11: The method of any of clauses 1-10, wherein the request message does not comprise an account identifier associated with the payment account and assigned by an issuer system.

Clause 12: A system for detecting fraudulent activity, comprising at least one processor programmed or configured to: generate at least one fraud control rule associated with at least one payment account parameter of a payment account; receive a request message from a user device, wherein the request message comprises social media data associated with a social media account of a user, wherein the social media data comprises unencrypted social media data and encrypted social media data; analyze the request message for fraudulent activity by analyzing the social media data with respect to the at least one fraud control rule; automatically generate a response message, the response message comprising at least one of: a processing request message associated with the request message in response to the social media data not satisfying the fraud control rule; and a rejection message in response to the social media data satisfying the fraud control rule; and communicate the response message.

Clause 13: The system of clause 12, wherein analyzing the social media data with respect to the at least one fraud control rule comprises: determining that the social media data corresponds to stored social media data; based on determining that the social media data corresponds to stored social media data, associating the social media data with the payment account; and determining whether the fraud control rule is satisfied.

Clause 14: The system of clause 12 or 13, wherein the stored social media data is stored in a transaction service provider database or an issuer database.

Clause 15: The system of any of clauses 12-14, wherein the at least one processor is further programmed or configured to: generate update data associated with the at least one payment account parameter in response to receiving the request message.

Clause 16: The system of any of clauses 12-15, wherein the at least one fraud control rule comprises a velocity control rule comprising a count and defining a count limit associated with processing request messages associated with the payment account, wherein generating the update data associated with the at least one payment account parameter in response to receiving the request message comprises incrementing the count.

Clause 17: The system of any of clauses 12-16, wherein the request message comprises at least one of: a payment transaction request message, an account validation inquiry request message, a balance inquiry request message, a fund transfer request message, and a payment device enrollment request message.

Clause 18: The system of any of clauses 12-17, wherein analyzing the social media data with respect to the at least one fraud control rule comprises analyzing the encrypted social media data without decrypting the encrypted social media data.

Clause 19: The system of any of clauses 12-18, wherein the encrypted social media data is homomorphically encrypted.

Clause 20: The system of any of clauses 12-19, wherein the request message comprises a public key.

Clause 21: The system of any of clauses 12-20, wherein in response to the social media data satisfying the fraud control rule, the at least one processor is further programmed or configured to generate and communicate a fraud alert message.

Clause 22: The system of any of clauses 12-21, wherein the request message does not comprise an account identifier associated with the payment account and assigned by an issuer system.

Clause 23: A computer program product for detecting fraudulent activity, the computer program product comprising at least one non-transitory computer-readable medium including one or more instructions that, when executed by the at least one processor, cause the at least one processor to: generate at least one fraud control rule associated with at least one payment account parameter of a payment account; receive a request message from a user device, wherein the request message comprises social media data associated with a social media account of a user, wherein the social media data comprises unencrypted social media data and encrypted social media data; analyze the request message for fraudulent activity by analyzing the social media data with respect to the at least one fraud control rule; automatically generate a response message, the response message comprising at least one of: a processing request message associated with the request message in response to the social media data not satisfying the fraud control rule; and a rejection message in response to the social media data satisfying the fraud control rule; and communicate the response message.

Clause 24: The computer program product of clause 23, wherein analyzing the social media data with respect to the at least one fraud control rule comprises: determining that the social media data corresponds to stored social media data; based on determining that the social media data corresponds to stored social media data, associating the social media data with the payment account; and determining whether the fraud control rule is satisfied.

Clause 25: The computer program product of clause 23 or 24, wherein the stored social media data is stored in a transaction service provider database or an issuer database.

Clause 26: The computer program product of any of clauses 23-25, wherein the one or more instructions cause the at least one processor to: generate update data associated with the at least one payment account parameter in response to receiving the request message.

Clause 27: The computer program product of any of clauses 23-26, wherein the at least one fraud control rule comprises a velocity control rule comprising a count and defining a count limit associated with processing request messages associated with the payment account, wherein generating the update data associated with the at least one payment account parameter in response to receiving the request message comprises incrementing the count.

Clause 28: The computer program product of any of clauses 23-27, wherein the request message comprises at least one of: a payment transaction request message, an account validation inquiry request message, a balance inquiry request message, a fund transfer request message, and a payment device enrollment request message.

Clause 29: The computer program product of any of clauses 23-28, wherein analyzing the social media data with respect to the at least one fraud control rule comprises analyzing the encrypted social media data without decrypting the encrypted social media data.

Clause 30: The computer program product of any of clauses 23-29, wherein the encrypted social media data is homomorphically encrypted.

Clause 31: The computer program product of any of clauses 23-30, wherein the request message comprises a public key.

Clause 32: The computer program product of any of clauses 23-31, wherein in response to the social media data satisfying the fraud control rule, the one or more instructions cause the at least one processor to generate and communicate a fraud alert message.

Clause 33: The computer program product of any of clauses 23-32, wherein the request message does not comprise an account identifier associated with the payment account and assigned by an issuer system.

Clause 34: A method for detecting fraudulent activity, comprising: generating, with at least one processor, at least one fraud control rule associated with at least one payment account parameter of a payment account; receiving, with at least one processor, a transaction request message from a user device associated with a user to initiate a payment flow event, wherein the transaction request message comprises social media data associated with the user; analyzing, with at least one processor, the social media data with respect to the at least one fraud control rule associated with the at least one payment account parameter; and automatically generating, with at least one processor, at least one of: a processing request message associated with the transaction request message in response to the social media data not satisfying the at least one fraud control rule associated with the at least one payment account parameter; and a rejection message in response to the social media data satisfying the at least one fraud control rule associated with the at least one payment account parameter.

Clause 35: The method of clause 34, further comprising: generating, with at least one processor, update data associated with the at least one payment account parameter in response to receiving the transaction request message.

Clause 36: The method of clause 34 or 35, wherein the at least one payment account parameter is associated with a value, the method further comprising incrementing the value in the update data based on a subsequent transaction request message.

Clause 37: The method of any of clauses 34-36, wherein the payment flow event comprises at least one of: a payment transaction and a fund transfer transaction.

Clause 38: The method of any of clauses 34-37, wherein the social media data comprises unencrypted social media data and encrypted social media data, wherein analyzing the social media data with respect to the at least one fraud control rule associated with the at least one payment account parameter comprises analyzing the encrypted social media data without decrypting the encrypted social media data.

Clause 39: The method of any of clauses 34-38, wherein the encrypted social media data is homomorphically encrypted.

Clause 40: The method of any of clauses 34-39, wherein the transaction request message comprises a public key.

Clause 41: The method of any of clauses 34-40, wherein in response to the social media data satisfying the at least one fraud control rule associated with the at least one payment account parameter, generating a fraud alert message.

Clause 42: The method of any of clauses 34-41, wherein the transaction request message does not comprise an account identifier associated with a financial account and assigned by an issuer system.

Clause 43: A method for detecting fraudulent activity, comprising: generating, with at least one processor, at least one fraud control rule associated with at least one account parameter of a user account; receiving, with at least one processor, an account validation inquiry request message from a user device associated with a user, wherein the account validation inquiry request message comprises social media data associated with the user; analyzing, with at least one processor, the social media data with respect to the at least one fraud control rule associated with the at least one account parameter; and automatically generating, with at least one processor, at least one of: a processing request message associated with the account validation inquiry request message in response to the social media data not satisfying the at least one fraud control rule associated with the at least one account parameter; and a rejection message in response to the social media data satisfying the at least one fraud control rule associated with the at least one account parameter.

Clause 44: The method of clause 43, further comprising: generating, with at least one processor, update data associated with the at least one account parameter in response to receiving the account validation inquiry request message.

Clause 45: The method of clause 43 or 44, wherein the at least one account parameter is associated with a value, the method further comprising incrementing the value in the update data based on a subsequent account validation inquiry request message.

Clause 46: The method of any of clauses 43-45, wherein the user account comprises a payment account associated with the user.

Clause 47: The method of any of clauses 43-46, wherein the social media data comprises unencrypted social media data and encrypted social media data, wherein analyzing the social media data with respect to the at least one fraud control rule associated with the at least one account parameter comprises analyzing the encrypted social media data without decrypting the encrypted social media data.

Clause 48: The method of any of clauses 43-47, wherein the encrypted social media data is homomorphically encrypted.

Clause 49: The method of any of clauses 43-48, wherein the account validation inquiry request message comprises a public key.

Clause 50: The method of any of clauses 43-49, wherein in response to the social media data satisfying the at least one fraud control rule associated with the at least one account parameter, generating a fraud alert message.

Clause 51: The method of any of clauses 43-50, wherein the account validation inquiry request message does not comprise an account identifier assigned by an issuer system of the account.

Clause 52: A method for detecting fraudulent activity, comprising: generating, with at least one processor, at least one fraud control rule associated with at least one account parameter of a user account; receiving, with at least one processor, a request message comprising at least one of a balance inquiry request message and a payment device enrollment request message from a user device associated with a user, wherein the request message comprises social media data associated with the user; analyzing, with at least one processor, the social media data with respect to the at least one fraud control rule associated with the at least one account parameter; and automatically generating, with at least one processor, at least one of: a processing request message associated with the request message in response to the social media data not satisfying the at least one fraud control rule associated with the at least one account parameter; and a rejection message in response to the social media data satisfying the at least one fraud control rule associated with the at least one account parameter.

Clause 53: The method of clause 52, further comprising: generating, with at least one processor, update data associated with the at least one account parameter in response to receiving the request message.

Clause 54: The method of clause 52 or 53, wherein the at least one account parameter is associated with a value, the method further comprising incrementing the value in the update data based on a subsequent request message.

Clause 55: The method of any of clauses 52-54, wherein the user account comprises a payment account associated with the user.

Clause 56: The method of any of clauses 52-55, wherein the social media data comprises unencrypted social media data and encrypted social media data, wherein analyzing the social media data with respect to the at least one fraud control rule associated with the at least one account parameter comprises analyzing the encrypted social media data without decrypting the encrypted social media data.

Clause 57: The method of any of clauses 52-56, wherein the encrypted social media data is homomorphically encrypted.

Clause 58: The method of any of clauses 52-57, wherein the request message comprises a public key.

Clause 59: The method of any of clauses 52-58, wherein in response to the social media data satisfying the at least one fraud control rule associated with the at least one account parameter, generating a fraud alert message.

Clause 60: The method of any of clauses 52-59, wherein the request message does not comprise an account identifier assigned by an issuer system of the account.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

Additional advantages and details of the disclosure are explained in greater detail below with reference to the non-limiting exemplary embodiments that are illustrated in the accompanying schematic figures, in which:

FIG. 1 shows a system for detecting fraudulent activity according to some non-limiting embodiments or aspects;

FIG. 2 shows a user device communicating a request message to a fraud detection processor according to some non-limiting embodiments or aspects;

FIG. 3 shows a data table associating social media data of a user with user data for the same user according to some non-limiting embodiments or aspects;

FIG. 4 shows a method for detecting fraudulent activity according to some non-limiting embodiments or aspects;

FIG. 5 shows a method for detecting fraudulent activity according to some non-limiting embodiments or aspects;

FIG. 6 shows a system for detecting fraudulent activity in a fund transfer application according to some non-limiting embodiments or aspects;

FIG. 7 shows a system for detecting fraudulent activity in a payment transaction application according to some non-limiting embodiments or aspects;

FIG. 8 shows a system for detecting fraudulent activity in an account validation application according to some non-limiting embodiments or aspects;

FIG. 9 shows a system for detecting fraudulent activity in a balance inquiry application according to some non-limiting embodiments or aspects; and

FIG. 10 shows a system for detecting fraudulent activity in a device enrollment application according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account identifier” may include one or more types of identifiers associated with a user account (e.g., a primary account number (PAN), a primary account number, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a payment device (e.g., a portable payment instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the term “acquirer” may refer to an entity licensed by the transaction service provider and approved by the transaction service provider to originate transactions (e.g., payment transactions) using a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions using a payment device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments, an acquirer may be a financial institution, such as a bank.

As used herein, the term “card-present transaction” may refer to a payment transaction initiated with a payment device in which the cardholder physically presents the payment device at the time the payment transaction is initiated with the payment device. A non-limiting example of a card-present transaction is a payment transaction initiated at a brick-and-mortar retail store with a physical POS system, during which the cardholder physically presents the payment device to the merchant.

As used herein, the term “card-not-present transaction” or “CNP transaction” may refer to a payment transaction initiated with a payment device in which the cardholder does not or cannot physically present the payment device at the time the payment transaction is initiated with the payment device. Non-limiting examples of CNP transactions include transactions initiated by mail or facsimile or a payment transaction initiated over the telephone or the internet.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may be a non-mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client.

As used herein, the term “encryption” refers to a method by which plaintext or any other type of data is converted from a readable form to an encoded version that can only be decoded by another entity if that entity has access to a decryption key. “Decryption” is the inverse of encryption, including the same steps but applied in the reverse order. Encryption may be used to protect certain sensitive data using one of any number of encryption techniques.

As used herein, the term “issuer institution” may refer to one or more entities, such as a bank, that provide accounts to users for conducting transactions (e.g., payment transactions), such as initiating credit and/or debit payments. For example, an issuer institution may provide an account identifier, such as a PAN, to a user that uniquely identifies one or more accounts associated with that user. The account identifier may be embodied on a payment device, such as a physical financial instrument, e.g., a payment card, and/or may be electronic and used for electronic payments. The term “issuer system” refers to one or more computer systems, computing devices, software applications, and/or the like operated by or on behalf of an issuer institution, such as a server computer executing one or more software applications. For example, an issuer system may include one or more authorization servers for authorizing a transaction, one or more authentication servers for authenticating a transaction, and/or one or more databases of account data. An issuer system may include a separate or integrated issuer authentication system, such as an Access Control Server (ACS), for authenticating online transactions. An issuer institution may be associated with a bank identification number (BIN) or other unique identifier that uniquely identifies it among other issuer institutions.

As used herein, the term “merchant” may refer to an individual or entity that provides goods and/or services, or access to goods and/or services, to users based on a transaction (e.g., a payment transaction). The term “merchant system” may refer to one or more computer systems, computing devices, and/or software applications operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, and/or the like) directly or indirectly communicating in the network environment may constitute a “system.” As used herein, the term “server” or “processor” may refer to one or more devices that provide a functionality to one or more devices (e.g., one or more client devices) via a network (e.g., a public network, a private network, the Internet, and/or the like). For example, a server may include one or more computing devices. As used herein, the term “system” may refer to one or more devices, such as one or more processors, servers, client devices, computing devices that include software applications, and/or the like. In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “social payment” refers to an electronic payment transaction initiated using social media, such as a social media account, and allows a user to transfer money to another person or business. A social payment may link directly to the user's bank account or debit/credit card information and can be initiated via a website or mobile application. The social payment may involve drawing money from the account when the user makes a payment and depositing money when a user receives a payment. The social payment may include a peer-to-peer payment, such as PayPal®, Venmo®, Apple Pay®, Google Pay®, and the like. A social payment may be initiated via a social media account such as on a social media platform and/or messaging service, such as Facebook®, WhatsApp®, Twitter®, and the like. The social payment may be executed via a client application running as a chatbot on the social media platform and/or messaging service.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “user interface” or “graphical user interface” refers to a generated display, such as one or more graphical user interfaces (GUIs) with which a user may interact, either directly or indirectly (e.g., through a keyboard, mouse, touchscreen, and/or the like).

Non-limiting embodiments or aspects of the present disclosure are directed to a method, system, and computer program product for detecting fraudulent activity. Non-limiting embodiments or aspects enable detection of potential fraudulent activity associated with a request (e.g., a fund transfer, a payment transaction, an account validation, a balance inquiry, a device enrollment, and/or the like) initiated via a user's social media account or otherwise with a user's social media data. The social media data may include public social media data (e.g., unencrypted social media data) and private social media data (e.g., encrypted social media data). Fraudulent activity may be detected based on fraud detection rules, some of which may include velocity control rules. The social media data may be used to determine whether the request may be fraudulent. The social media data may be encrypted in the request. The encrypted social media data may be analyzed to determine potential fraudulent activity without decrypting the social media data.

In this way, non-limiting embodiments or aspects enable a fraud alert to be communicated to the user if at least one of the fraud rules is satisfied. The request message may not include any account identifier assigned by the account issuing system and associated with the account of the user, but may determine the fraudulent activity based on the social media data in the request message. Further, non-limiting embodiments or aspects enable the detection of fraudulent activity during processing of social payments that initiated on social media platforms. For example, non-limiting embodiments or aspects may allow a transaction processing systems to obtain fraud detection parameters for the fraud control rules that are used to detect fraudulent activity during processing of social payments. In addition, a transaction processing system may not need to perform checks (e.g., account level checks) on an account involved in a social payment based on fraud control rules that require fraud detection parameters, such as a PAN, an identifier of a device (e.g., a device identifier, an IP address of a device, and/or the like) involved in the electronic payment transaction, and/or a BIN, to detect potentially fraudulent transactions. In this way, network resources used to detect potentially fraudulent transaction may be reduced since the fraud detection parameters may not need to be obtained and/or a check based on the fraud control rules does not need to be applied.

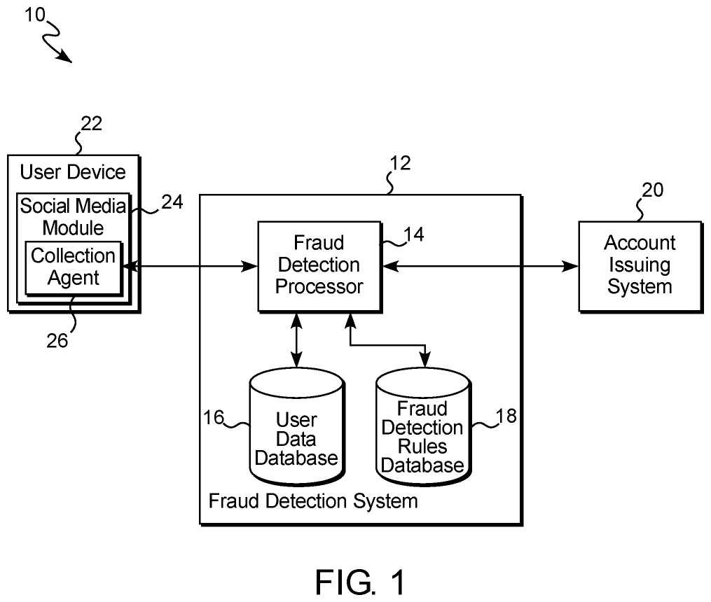

Referring to FIG. 1, a system 10 for detecting fraudulent activity is shown according to some non-limiting embodiments or aspects. The system 10 may include a fraud detection system 12 including a fraud detection processor 14, a user data database 16, and a fraud detection rules database 18. The fraud detection system 12 may be operated by or on behalf of a transaction service provider, an acquirer, an issuer, a social media entity, or other fraud monitoring entity.

With continued reference to FIG. 1, the system 10 may further include an account issuing system 20 in communication with the fraud detection system 12. The account issuing system 20 may be operated by or on behalf of an entity which issued an account to a user. The account may be a financial account, such as a bank account, credit card account, debit card account, or other type of payment account. In some non-limiting embodiments or aspects in which the account is a financial account, the account issuing system 20 may be operated by or on behalf of an issuer bank. The account may be a secure non-financial account that includes login credentials to restrict access to the account, in which case the account issuing system 20 may be operated by or on behalf of the entity issuing the account to the user. The fraud detection system 12 may detect potential fraudulent activity associated with the account issued by the account issuing system 20.

The fraud detection processor 14 may generate at least one fraud control rule associated with at least one account parameter of the account. Generating the fraud control rules may include the fraud detection processor 14 obtaining (receiving and/or retrieving) fraud control rules from the account issuing system 20, or determining the fraud control rules to detect potential fraud associated with the account. The fraud detection processor 14 may communicate with the fraud detection rules database 18 to store the fraud detection rules.

The account parameter associated with the fraud control rules may include any user data described hereinafter, which includes any of the social media data described hereinafter.

The fraud control rules may include an activity or activities, a threshold for an activity or sequence of activities, and/or the like, which, if satisfied, may indicate potential fraud associated with the account of the user. A fraud rule being satisfied may indicate potential fraud associated with the account of the user, while a fraud rule not being satisfied may indicate that the activity or sequence of activities associated with the account is not identified as potentially fraudulent. The fraud control rules may include at least one velocity control rule. A velocity control rule may include a limit on the number of times that a particular activity or sequence of activities may occur over a specified time period. As a non-limiting example, in account verification applications, a velocity control rule may specify that a user may verify their account up to 3 times over the course of 24 hours, such that the fourth time in one day that an account verification request is received for the same user, the fraud control rule, in the form of a velocity control rule, is satisfied, indicating potential fraudulent activity. As a non-limiting example, in fund transfer applications, a velocity control rule may specify that a user may perform 3 fund transfers over the course of 24 hours, such that the fourth time in one day that a fund transfer request is received for the same user, the fraud control rule, in the form of a velocity control rule, is satisfied, indicating potential fraudulent activity.

The fraud control rules may include at least one limit rule. A limit rule may provide a maximum or minimum value associated with an activity or sequence of activities, such that if the maximum value is exceeded or the minimum value is not exceeded, the fraud control rule may be satisfied. As a non-limiting example, in fund transfer applications, a limit rule may specify that a user may transfer up to $2,500 in a single transfer, such that if the user attempts to transfer more than the $2,500 transfer limit, the fraud control rule, in the form of a limit rule, is satisfied, indicating potential fraudulent activity.

Other types of fraud control rules may be used, such as a rule identifying a specific potentially fraudulent activity or sequence of activities, a rule requiring a specific activity or sequence of activities to occur in order for the request to not be potentially fraudulent, or any other rule which may indicate potential fraudulent activity.

With continued reference to FIG. 1, the fraud detection processor 14 may communicate with the user data database 16 to store user data. The user data may include account data associated with the account of the user (e.g., PANs, BINs, transaction history, balances, and the like). The user data may include data associated with activity associated with the account of the user, such as a history or count of account validation attempts; a history or count of device enrollment attempts, as well as the device data enrolled with the account (the devices including computing devices and/or payment devices); a history or count of balance inquiry attempts; and the like. The user data may include data associated with payment transactions and/or fund transfers initiated by the user, such as with a payment device, such as data elements from ISO 8583 associated with user payment transactions. The user data may include any other parameter associated with a fraud rule stored in the fraud detection rules database 18.

The user data may include social media data. Social media data may include any profile data generated by a social media platform associated with a user and/or a social media account of the user. Non-limiting examples of social media data include a social media user identifier, a social media name (e.g., first name, last name, pseudonym, handle, and the like), a social media email identifier, a social media username, a social media password, a date of birth stored on a social media account, a gender stored on a social media account, location data obtained by a social media account, and any other data obtained by and/or stored on a social media account of the user.

The social media data may include public data and/or private data. The public data may include data which is publicly viewable on the user's social media account and/or is not required to be released by the user in order to be publicly viewable. The private data may include data which is not publicly viewable on the user's social media account and/or is required to be released by the user in order to be publicly viewable. User privacy agreements between the social media entity and the user may determine whether certain social media data is public data or private data. Non-limiting examples of public social media data include: a social media user identifier, a social media name (e.g., first name, last name, pseudonym, handle, and the like), and the like. Non-limiting examples of private social media data include: a social media email identifier, a social media username, a social media password, a date of birth stored on a social media account, a gender stored on a social media account, location data obtained by a social media account, and the like.

With continued reference to FIG. 1, the user data stored on the user data database 16 may be obtained from at least one source. The account issuing system 20 may provide certain user data to the fraud detection system 12 for storage in the user data database 16. The social media entity may provide certain user data to the fraud detection system 12 for storage in the user data database 16. Previous user data obtained by the fraud detection system 12 during processing of a previous request from the user may be stored in the user data database 16. The fraud detection system 12 may obtain user data from an electronic payment processing network over which electronic payment transactions are conducted associated with the user, and this user data may be stored in the user data database 16. The user data stored in the user data database 16 may be obtained from any other suitable source, such as a transaction service provider system, an issuer system, a merchant system, and acquirer system, and the like.

With continued reference to FIG. 1, a user device 22 (e.g., a computing device, such as a smartphone or other computer) associated with a user may communicate a request message to the fraud detection system 12 (e.g., the fraud detection processor 14) to initiate processing of a request. The request message may include at least one of: a payment transaction request message, an account validation inquiry request message, a balance inquiry request message, a fund transfer request message, and a payment device enrollment request message.

The request message may include social media data associated with a social media account of the user. The social media data may include public and/or private social media data. The request message may not include any account identifier associated with the account of the user and assigned by or on behalf of the entity which issued the account (e.g., a PAN, a BIN, and the like).

The request may be initiated by the user device 22 via a social media module 24 that causes information to be displayed on the user device 22. The social media module 24 may, for example, include a social media application (e.g., a social media account mobile application) that allows a social media account website associated with the user to be accessed by the user via the user device 22. However, it will be appreciated that other arrangements for accessing the user's social media account so as to initiate the request may be used. The social media module 24 may include a chatbot for initiating the requests, and/or the request may be initiated via a messaging application on the social media module 24. A “chatbot” may refer to a computer program which conducts a conversation via auditory or textual methods.

With continued reference to FIG. 1, a collection agent 26 may be embedded as part of the social media module 24. The collection agent 26 may include a software development kit (SDK) provided by the fraud detection system 12, or an entity associated therewith, with source code configured to gather social media data from various social media application programming interfaces (APIs) in response to initiation of a request. In response to gathering the relevant social media data for the request message of the request, the collection agent 26 may communicate the request message to the fraud detection system 12 (e.g., the fraud detection processor 14).

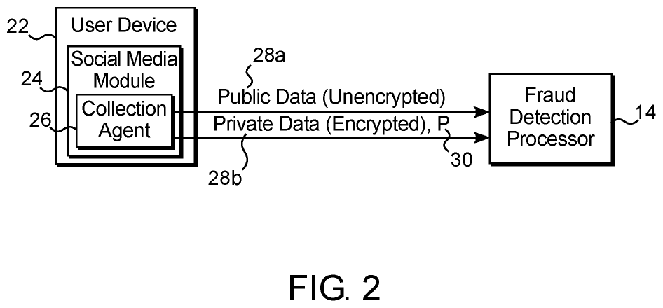

Referring to FIGS. 1-3, the collection agent 26 and/or the social media module 24 (e.g., the chatbot or messaging application) may include a public key 30 to enable encryption of at least a portion of the social media data 28 (e.g., private social media data 28b which is encrypted) contained in the request message. The request message may include public social media data 28b which is not encrypted. The public key 30 may be created by the account issuing system 20, the fraud detection system 12, the social media entity, or the like, and the public key may be shared with the fraud detection system 12, so as to permit analysis of received encrypted social media data 28 in the request message. The private social media data 28b may be encrypted by the social media module 24 and/or the collection agent 26. In some non-limiting embodiments or aspects, the private social media data 28b may be encrypted using homomorphic encryption, such as full homomorphic encryption. Other techniques of encryption may be used to encrypt the private social media data 28b.

In response to the user initiating the request on the user device 22, the social media module 24 and/or the collection agent 26 may generate the request message. The social media module 24 and/or collection agent 26 may gather the relevant social media data 28 for processing the request. The social media module 24 and/or collection agent 26 may encrypt any of the private social media data 28b to be included in the request message. The generated request message may include unencrypted public social media data 28a and/or encrypted private social media data 28b. The generated request message may also include the public key if the request message includes any encrypted private social media data 28b. The generated request message may be sent from the user device 22 to the fraud detection processor 14.

With continued reference to FIGS. 1-3, in response to receiving the request message including the social media data 28, the fraud detection processor 14 may analyze the request message for potentially fraudulent activity. The social media data 28 may be analyzed based on the fraud control rules to determine whether the request is potentially fraudulent. The fraud detection processor 14 may analyze at least a portion of the social media data 28 received from the request message, the user data stored in the user data database 16, and/or the fraud control rules in the fraud detection rules database 18, alone or in combination, to determine whether the request is potentially fraudulent. The fraud detection processor 14 may determine that at least one of the fraud control rules are satisfied using the social media data 28 from the request message and determine that the request is potentially fraudulent. The fraud detection processor 14 may determine that none of the fraud control rules is satisfied using the social media data 28 from the request message and determine that the request is not considered potentially fraudulent.

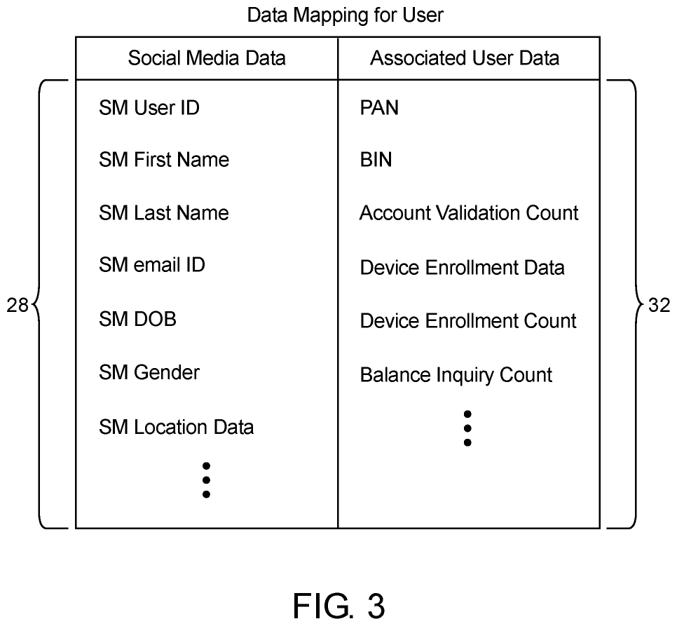

In some non-limiting embodiments or aspects, the fraud detection processor 14 may analyze the social media data 28 with respect to the fraud detection rules by determining that the social media data 28 from the request message corresponds to social media data 28 stored in the user data database 16. Based on determining that the social media data 28 from the request message corresponds to social media data 28 stored in the user data database 16, the fraud detection processor 14 may determine the account associated with the user. As shown in FIG. 3, the user data database 16 may associate social media data 28 with other associated user data 32, which may include data associated with the account of the user. In this way, the social media data 28 from the request message may be used to determine other associated user data 32 associated with the account of the user corresponding thereto. Based on determining the account of the user, the fraud detection processor 14 may determine whether at least one of the fraud control rules is satisfied. In some non-limiting examples, the fraud control rules may be based on the social media data 28, such that the social media data 28 itself, rather than other associated user data 32 associated with the account of the user, is analyzed to determine whether at least one of the fraud control rules is satisfied.

With continued reference to FIG. 1, in some non-limiting embodiments or aspects, upon analyzing the request message based on social media data, update data, and/or fraud control rules, the fraud detection processor 14 may generate and store update data associated with the user (e.g., an account of the user). The update data may be stored in the user data database 16.

The update data may include updated count data. For example, the fraud control rule may include a velocity control rule including a count defining a count limit (e.g. over a predetermined time period) associated with at least one account parameter. The account parameter may include the social media data in the request message or other user data associated with the account and/or the social media data. The update data generated by the fraud detection processor 14 may include an updated count data, which increments the previous count by 1. As a non-limiting example, in account verification applications, a velocity control rule may specify that a user may verify their account up to 3 times over the course of 24 hours, such that the fourth time in one day that an account verification request is received for the same user, the fraud control rule, in the form of a velocity control rule, is satisfied, indicating potential fraudulent activity. The user data may include a count of the number of times an account verification request has been received in the last 24 hours, which may be associated with social media data of the user received in the account verification request message. Upon receiving a subsequent account verification request from the user, the fraud detection processor 14 may determine that the fraud rule was not satisfied (the daily limit of account verification requests was not reached), and the fraud detection processor 14 may increment the count of the number of times an account verification request has been received in the last 24 hours by 1 as update data. This update data may be stored on the user data database 16.

With continued reference to FIGS. 1-3, in some non-limiting embodiments or aspects, analyzing the social media data from the request message with the fraud detection processor 14 may include decrypting the encrypted the private social media data 28b. The fraud detection processor 14 may decrypt the encrypted the private social media data 28b in response to receiving the public key in the request message. The fraud detection processor 14 may analyze the decrypted private social media data 28b and/or the already unencrypted public social media data 28a with respect to the fraud control rules, as previously discussed.

With continued reference to FIGS. 1-3, in some non-limiting embodiments or aspects, analyzing the social media data from the request message with the fraud detection processor 14 may include analyzing the encrypted private social media data 28b without decrypting the private social media data 28b. In this way, the fraud detection system 12 may analyze the encrypted private social media data 28b without ever decrypting the encrypted private social media data 28b. For example, the encrypted private social media data 28b may be homomorphically encrypted such that the encrypted private social media data 28b may be analyzed without first decrypting the encrypted private social media data 28b. In some non-limiting examples, the value of the homomorphically encrypted parameter (e.g., social media date of birth of the user) may be compared with the corresponding homomorphically encrypted parameter stored in the user data database 16 or received from another suitable data source (e.g., date of birth of the user received from the account issuing system 20) to determine whether the parameters match. Other encryption methods that enable the fraud detection system 12 to analyze the social media data with respect to the fraud control rules without decrypting the encrypted private social media data 28b may be used.

With continued reference to FIG. 1, upon analyzing the request message for potential fraudulent activity, the fraud detection processor 14 may automatically generate a response message including at least one of: a processing request message associated with the request message in response to the social media data not satisfying any of the fraud control rules; and a rejection message in response to the social media data satisfying at least one of the fraud control rules. The processing request message and/or the rejection message may be communicated to the user device 22, account issuing system 20, and/or another device, processor, system, or the like (hereinafter “downstream processor”) involved in processing the request associated with the request message.

The processing request message may cause the user device 22 or downstream processor to continue processing the request to completion, as the fraud detection system 12 did not detect any potentially fraudulent activity.

The rejection message may cause the user device 22 or downstream processor to terminate processing of the request to completion, as the fraud detection system 12 detected potentially fraudulent activity based on the fraud control rules. The rejection message may specify the fraud control rule which was satisfied and indicated potentially fraudulent activity. The rejection message may be communicated to a representative associated with the fraud detection system 12 or the account issuing system 20 for further review of the potentially fraudulent activity. The rejection message may include a fraud alert message to notify the user and/or the account issuing system 20 of the potentially fraudulent activity.

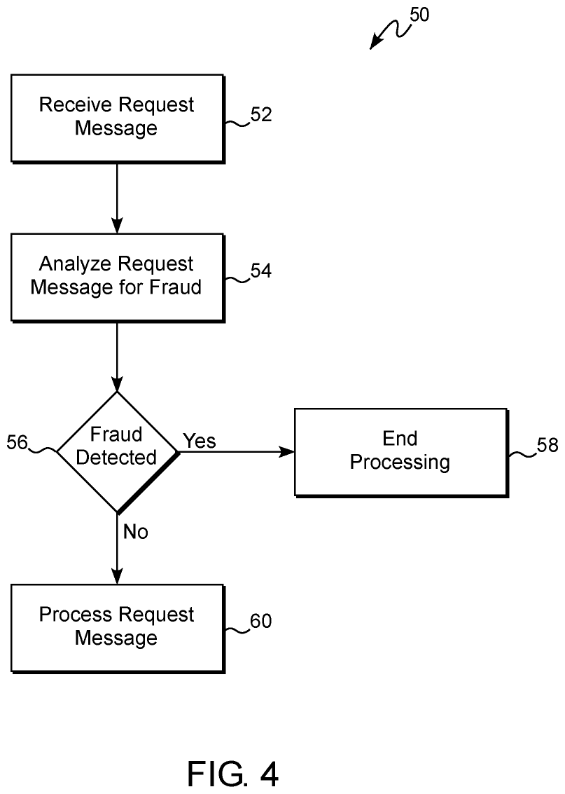

Referring to FIG. 4, a method 50 for detecting fraudulent activity according to some non-limiting embodiments or aspects is shown. At a step 52, the fraud detection system may receive a request message from the user device. At a step 54, the fraud detection system may analyze the request message for potential fraud based on the social media data in the request message and the fraud control rules. At a step 56, the fraud detection system may determine whether the request is potentially fraudulent. At a step 58, upon the fraud detection system determining that the request is potentially fraudulent, the fraud detection system may generate and communicate a rejection message to cause termination of the processing of the request. At a step 60, upon the fraud detection system determining that the request is not potentially fraudulent, the fraud detection system may generate and communicate a processing request message to cause continued processing of the request.

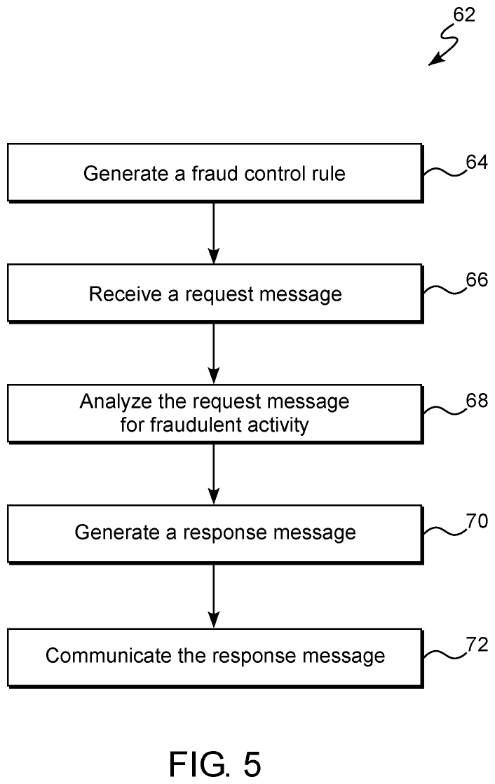

Referring to FIG. 5, a method 62 for detecting fraudulent activity according to some non-limiting embodiments or aspects is shown. At a step 64, the fraud detection system may generate at least one fraud control rule associated with at least one payment account parameter of a payment account, which may include storing in the fraud detection rules database a fraud control rule obtained by or generated by the fraud control system.

With continued reference to FIG. 5, at a step 66, the fraud detection system may receive a request message from a user device. The request message may include social media data associated with a social media account of a user. The social media data may include unencrypted social media data and/or encrypted social media data. At a step 68, the fraud detection system may analyze the request message for fraudulent activity by analyzing the social media data with respect to the at least one fraud control rule.

With continued reference to FIG. 5, at a step 70, the fraud detection system may automatically generate a response message. The response message may include a processing request message associated with the request message in response to the social media data not satisfying the fraud control rule. The response message may include a rejection message in response to the social media data satisfying the fraud control rule. At a step 72, the fraud detection system may communicate the response message.

In a further, non-limiting embodiment or aspect, a computer program product for detecting fraudulent activity includes at least one non-transitory computer readable medium including program instructions that, when executed by at least one processor, cause the at least one processor to execute one or more of the previously-described methods. The at least one processor may include the fraud detection processor and/or the account issuing system.

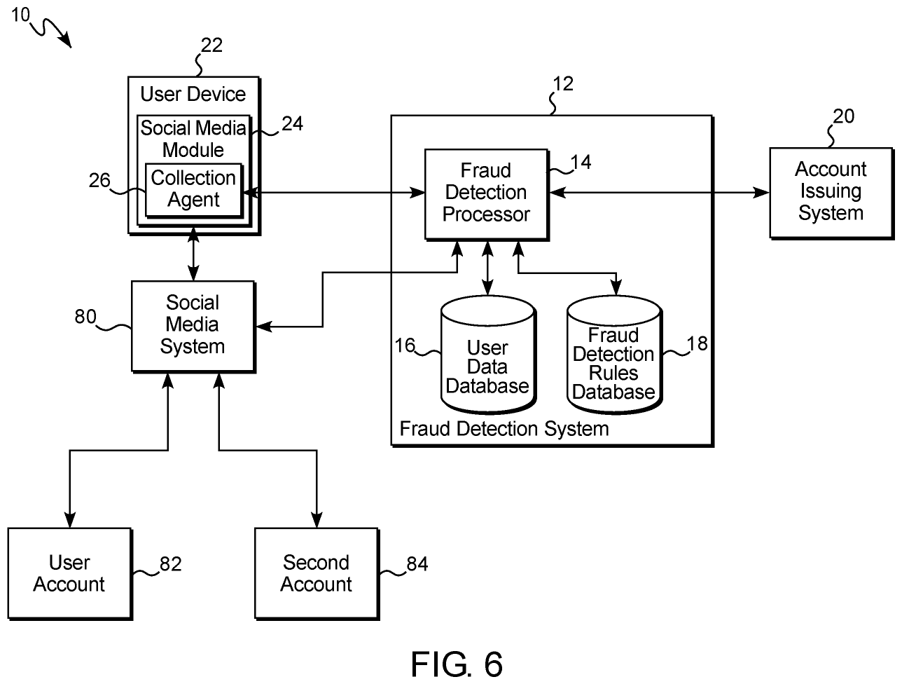

Referring to FIGS. 6-10, non-limiting embodiments or aspects of systems 10 for detecting fraudulent activity incorporated into one or more systems involving a user account are shown. Each system including the above-described system 10 for detecting fraudulent activity will be described hereinafter to illustrate further specific non-limiting aspects of the disclosure.

Referring to FIG. 6, a system 10 for detecting fraudulent activity in a fund transfer system according to some non-limiting embodiments or aspects is shown. The fund transfer system may enable a user to transfer funds from the user account 82 to a second account 84 of another individual or business (or vice versa). Non-limiting examples include peer-to-peer fund transfers. The user account 82 and/or the second account 84 may include a financial account configured to make payments (a payment account). The account issuing system 20 may be the issuer bank which issued the user account 82 to the user. The user account 82 may have an account identifier (e.g., a PAN) issued by the issuer. The fraud detection system 12 may be operated by or on behalf of the issuer, a transaction service provider associated with the user account 82, or the like.

With continued reference to FIG. 6, the user may initiate the fund transfer request via the social media account of the user, such as via the social media module 24 displayed on the user device 22. The social media account may be linked to the user account 82 to enable such fund transfers via the user's social media account. The user device 22 may generate and communicate the request message as previously described, where the request message is a fund transfer request message configured to cause funds to be transferred to or from the user account 82 to or from the second account 84.

The fund transfer request message may include social media data. The fund transfer request message may not include the account identifier issued by the issuer and associated with the user account 82. The fraud detection system 12 may analyze the social media data with respect to the at least one fraud control rule, as previously described, where the fraud control rules are associated with at least one payment account parameter. The payment account parameter may be, for example, any parameter stored in the user data database 16 and associated with the user account 82.

Non-limiting examples of specific fraud control rules that may be implemented in the fund transfer application include: maximum and/or minimum fund transfer amount for a single transfer, maximum and/or minimum fund transfer amount over a predetermined time period, maximum or minimum fund transfer count over a predetermined time period, a restriction as to accounts which the funds may be transferred to or from (e.g., only to individuals or businesses within the user's social media “friends” or to/from certain BINs), a restriction on the reason for the fund transfer, a restriction based on the available balance of funds in the user account, a restriction based on a location of the user initiating the fund transfer as obtained by the social media account, a status of the social media account (e.g., a social media account recently hacked, and the like), and the like. These fraud control rules may be implemented based on all activity associated with the user account or based on activity initiated via a social media account of the user that is associated with the user account.

In response to analyzing the social media data and determining that no potentially fraudulent activity is associated with the fund transfer request, the fraud detection system 12 may generate and communicate the processing request message. The processing request message may be communicated to the user device 22 and/or a social media system 80 operated by or on behalf of the social media entity. The social media system 80 refers to one or more computer systems, computing devices, software applications, and/or the like operated by or on behalf of the social media entity, such as a server computer executing one or more software applications. The processing request message may cause the social media system 80 to process the fund transfer request to completion. Processing the fund transfer request to completion may include the social media system 80 causing funds to be transferred between the user account 82 and the second account 84. For example, the social media system 80 may cause funds to transfer from the user account 82 to the second account 84 if the user is the payor. For example, the social media system 80 may cause funds to transfer from the second account 84 to the user account 82 if the user is the payee.

In response to analyzing the social media data and determining that potentially fraudulent activity is associated with the fund transfer request, the fraud detection system 12 may generate and communicate the rejection message, which may cause the fund transfer request to be terminated. A fraud alert message may be communicated to the user (e.g., user device 22).

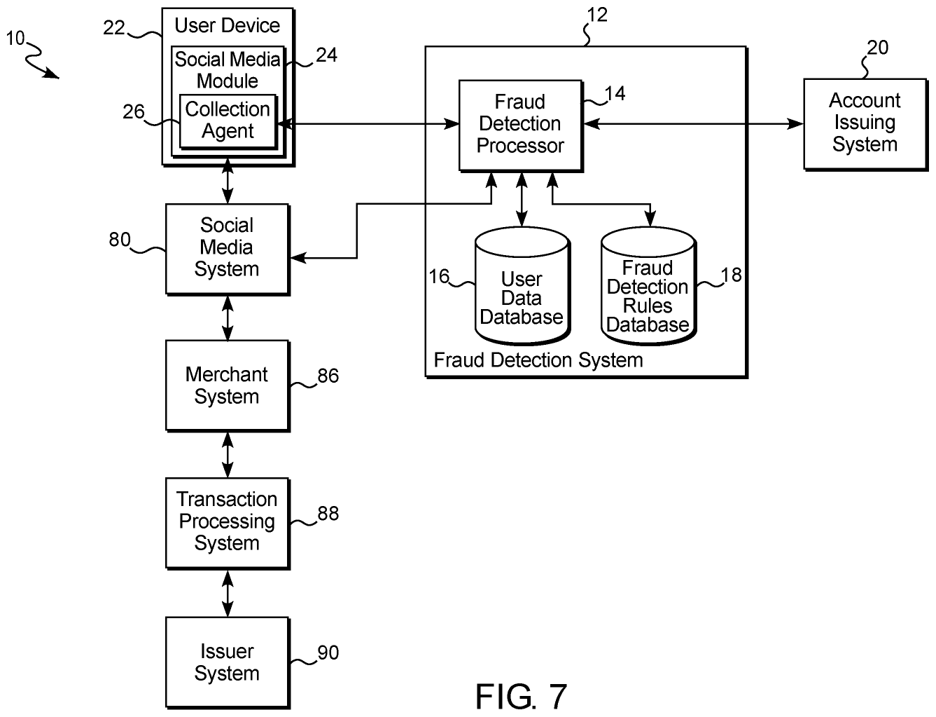

Referring to FIG. 7, a system 10 for detecting fraudulent activity in a payment transaction system according to some non-limiting embodiments or aspects is shown. The payment transaction system may enable a user to conduct an electronic payment transaction (e.g., with a merchant) from a user account. The user account may include a financial account configured to make payments (a payment account). The payment account may be associated with a payment device, such as a credit and/or debit card. The account issuing system 20 may be the issuer bank which issued the payment account to the user. The payment account may have an account identifier (e.g., a PAN) issued by the issuer. The fraud detection system 12 may be operated by or on behalf of the issuer, a transaction service provider associated with the payment account, or the like.

With continued reference to FIG. 7, the user may initiate the payment transaction request via the social media account of the user, such as via the social media module 24 displayed on the user device 22. The social media account may be linked to the payment account to enable the electronic payment transaction to be initiated via the user's social media account. The user device 22 may generate and communicate the request message as previously described, where the request message is a payment transaction request message configured to initiate the electronic payment transaction between the user and the merchant.

The payment transaction request message may include social media data. The payment transaction request message may not include the account identifier issued by the issuer and associated with the payment account. The fraud detection system 12 may analyze the social media data with respect to the at least one fraud control rule, as previously described, where the fraud control rules are associated with at least one payment account parameter. The payment account parameter may be, for example, any parameter stored in the user data database 16 and associated with the payment account.

Non-limiting examples of specific fraud control rules that may be implemented in the payment transaction application include: maximum and/or minimum payment transaction amount for a single payment transaction, maximum and/or minimum payment transaction amount over a predetermined time period, maximum or minimum payment transaction count over a predetermined time period, a restriction as to goods and/or services which may be purchased or the merchant from which the user may purchase goods and/or services (e.g., as determined by merchant category codes (MCC) or data in the user's social media account), a restriction based on the available balance of funds in the payment account or credit limit associated with the payment account, a restriction based on a location of the user initiating the payment transaction as obtained by the social media account, a status of the social media account (e.g., a social media account recently hacked, and the like), and the like. These fraud control rules may be implemented based on all activity associated with the payment account or based on activity initiated via a social media account of the user that is associated with the payment account.

In response to analyzing the social media data and determining that no potentially fraudulent activity is associated with the payment transaction request, the fraud detection system 12 may generate and communicate the processing request message. The processing request message may be communicated to the user device 22 and/or the social media system 80. The processing request message may cause the social media system 80 to process the payment transaction request to completion.

Processing the payment transaction request to completion may include the social media system 80 communicating with a merchant system 86 operated by or on behalf of the merchant involved in the payment transaction. The merchant system 86 may communicate with a transaction processing system 88 operated by or on behalf of a transaction service provider of a payment device being used by the user for the payment transaction and an issuer system 90 operated by or on behalf of an issuer of a payment device being used by the user for the payment transaction to process the payment transaction. Processing the payment transaction may include authorizing, clearing, and settling the payment transaction. The transaction processing system 88, the issuer system 90, and/or the account issuing system 20 may be operated by or on behalf of the same entity.

In response to analyzing the social media data and determining that potentially fraudulent activity is associated with the payment transaction request, the fraud detection system 12 may generate and communicate the rejection message, which may cause the payment transaction request to be terminated. A fraud alert message may be communicated to the user (e.g., user device 22).

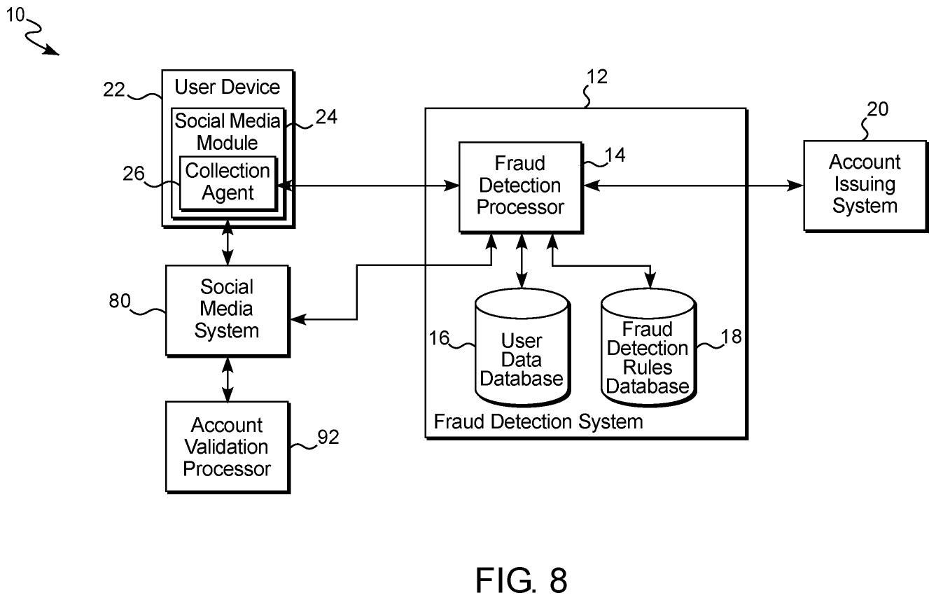

Referring to FIG. 8, a system 10 for detecting fraudulent activity in an account validation system according to some non-limiting embodiments or aspects is shown. The account validation system may enable a user check whether a user account is valid and/or in good standing. The user account may include a financial account configured to make payments (a payment account) or a non-financial account associated with the user. The account issuing system 20 may be the issuer bank which issued the financial account to the user or the issuer of the non-financial account of the user. The user account may have an account identifier (e.g., a PAN) issued by the issuer. The fraud detection system 12 may be operated by or on behalf of the issuer of the user account, a transaction service provider associated with the account, or the like.

With continued reference to FIG. 8, the user may initiate the account validation request via the social media account of the user, such as via the social media module 24 displayed on the user device 22. The social media account may be linked to the user account to enable the account validation to be initiated via the user's social media account. The user device 22 may generate and communicate the request message as previously described, where the request message is an account validation request message configured to initiate the communication of the status of the user account to the user device 22.

The account validation request message may include social media data. The account validation request message may not include the account identifier issued by the issuer and associated with the user account. The fraud detection system 12 may analyze the social media data with respect to the at least one fraud control rule, as previously described, where the fraud control rules are associated with at least one user account parameter. The user account parameter may be, for example, any parameter stored in the user data database 16 and associated with the user account.

Non-limiting examples of specific fraud control rules that may be implemented in the account validation application include: maximum and/or minimum account validation requests permitted over a predetermined time period, a restriction as to when during a day an account validation request may be processed, a restriction based on a location of the user initiating the account validation request as obtained by the social media account, a status of the social media account (e.g., a social media account recently hacked, and the like), and the like. These fraud control rules may be implemented based on all activity associated with the user account or based on activity initiated via a social media account of the user that is associated with the user account.

In response to analyzing the social media data and determining that no potentially fraudulent activity is associated with the account validation request, the fraud detection system 12 may generate and communicate the processing request message. The processing request message may be communicated to the user device 22 and/or the social media system 80. The processing request message may cause the social media system 80 to process the account validation request to completion.

Processing the account validation request to completion may include the social media system 80 communicating with an account validation processor 92 operated by or on behalf of the issuer of the user account and/or a transaction service provider associated with the user account. The account validation processor 92 may determine a status of the user account (e.g., that the user account is valid/invalid and/or in good standing/not in good standing). The account validation processor 92 may communicate the status of the user account to the social media system 80, which may communicate the status of the user account to the user device 22.

In response to analyzing the social media data and determining that potentially fraudulent activity is associated with the account validation request, the fraud detection system 12 may generate and communicate the rejection message, which may cause the account validation request to be terminated. A fraud alert message may be communicated to the user (e.g., user device 22).

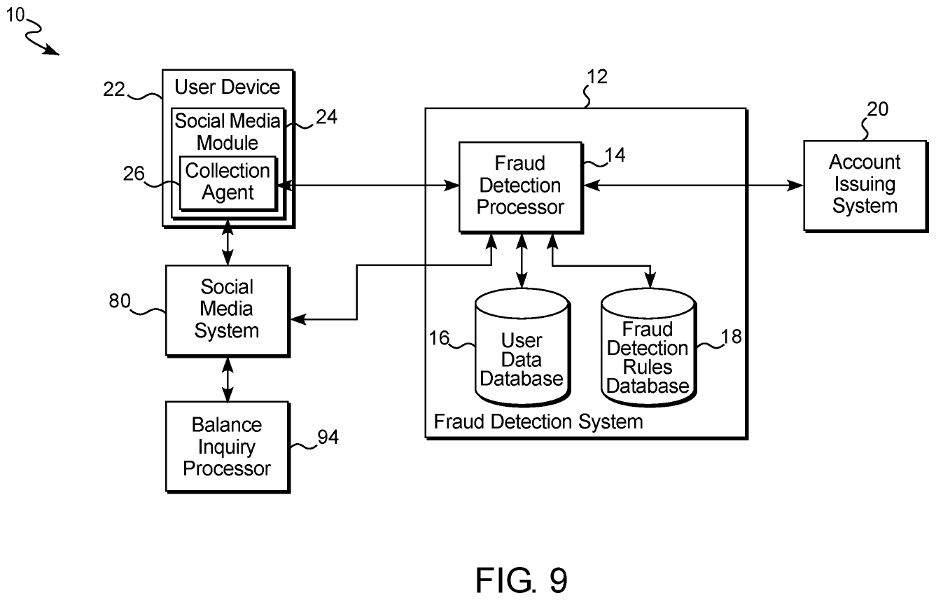

Referring to FIG. 9, a system 10 for detecting fraudulent activity in a balance inquiry system according to some non-limiting embodiments or aspects is shown. The balance inquiry system may enable a user to check a balance associated with a user account. The user account may include a financial account configured to make payments (a payment account) or a non-financial account associated with the user and having an associated balance. The account issuing system 20 may be the issuer bank which issued the financial account to the user or the issuer of the non-financial account of the user. The user account may have an account identifier (e.g., a PAN) issued by the issuer. The fraud detection system 12 may be operated by or on behalf of the issuer of the user account, a transaction service provider associated with the account, or the like.

With continued reference to FIG. 9, the user may initiate the balance inquiry request via the social media account of the user, such as via the social media module 24 displayed on the user device 22. The social media account may be linked to the user account to enable the balance inquiry to be initiated via the user's social media account. The user device 22 may generate and communicate the request message as previously described, where the request message is a balance inquiry request message configured to initiate the communication of the balance of the user account to the user device 22.

The balance inquiry request message may include social media data. The balance inquiry request message may not include the account identifier issued by the issuer and associated with the user account. The fraud detection system 12 may analyze the social media data with respect to the at least one fraud control rule, as previously described, where the fraud control rules are associated with at least one user account parameter. The user account parameter may be, for example, any parameter stored in the user data database 16 and associated with the user account.

Non-limiting examples of specific fraud control rules that may be implemented in the balance inquiry application include: maximum and/or minimum balance inquiry requests permitted over a predetermined time period, a restriction as to when during a day a balance inquiry request may be processed, a restriction based on the BIN associated with the user payment device, a restriction based on a location of the user initiating the balance inquiry request as obtained by the social media account, a status of the social media account (e.g., a social media account recently hacked, and the like), and the like. These fraud control rules may be implemented based on all activity associated with the user account or based on activity initiated via a social media account of the user that is associated with the user account.

In response to analyzing the social media data and determining that no potentially fraudulent activity is associated with the balance inquiry request, the fraud detection system 12 may generate and communicate the processing request message. The processing request message may be communicated to the user device 22 and/or the social media system 80. The processing request message may cause the social media system 80 to process the balance inquiry request to completion.

Processing the balance inquiry request to completion may include the social media system 80 communicating with a balance inquiry processor 94 operated by or on behalf of the issuer of the user account and/or a transaction service provider associated with the user account. The balance inquiry processor 94 may determine a balance of the user account. The balance inquiry processor 94 may communicate the balance of the user account to the social media system 80, which may communicate the balance of the user account to the user device 22.

In response to analyzing the social media data and determining that potentially fraudulent activity is associated with the balance inquiry request, the fraud detection system 12 may generate and communicate the rejection message, which may cause the balance inquiry request to be terminated. A fraud alert message may be communicated to the user (e.g., user device 22).

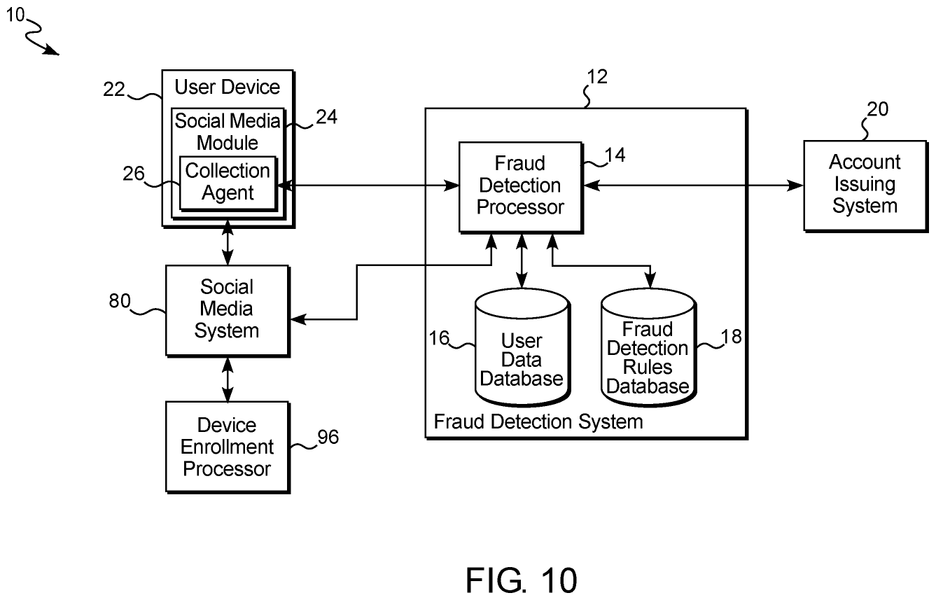

Referring to FIG. 10, a system 10 for detecting fraudulent activity in a device enrollment system according to some non-limiting embodiments or aspects is shown. The device enrollment system may enable the user to associate (e.g., register/enroll) a device (e.g., a payment device and/or a computing device) with a user account. The user account may include a financial account configured to make payments (a payment account) or a non-financial account associated with the user to which devices may be associated. For example, a user payment account may have payment devices registered thereto to allow the user to initiate transactions using a payment device. For example, a user account may have user computing devices associated therewith which may be enabled to modify at least one aspect of the user account or initiate a transaction therefrom. The account issuing system 20 may be the issuer bank which issued the financial account to the user or the issuer of the non-financial account of the user. The user account may have an account identifier (e.g., a PAN) issued by the issuer. The fraud detection system 12 may be operated by or on behalf of the issuer of the user account, a transaction service provider associated with the account, or the like.

With continued reference to FIG. 10, the user may initiate the device enrollment request via the social media account of the user, such as via the social media module 24 displayed on the user device 22. The social media account may be linked to the user account to enable the device enrollment request to be initiated via the user's social media account. The user device 22 may generate and communicate the request message as previously described, where the request message is a device enrollment request message configured to initiate the association of a device with the user account.

The device enrollment request message may include social media data. The device enrollment request message may not include the account identifier issued by the issuer and associated with the user account. The fraud detection system 12 may analyze the social media data with respect to the at least one fraud control rule, as previously described, where the fraud control rules are associated with at least one user account parameter. The user account parameter may be, for example, any parameter stored in the user data database 16 and associated with the user account.

Non-limiting examples of specific fraud control rules that may be implemented in the device enrollment application include: a maximum number of devices already being associated with the user account, an insufficient number of devices being associated with the user account, a maximum number of devices already having been associated with the user account over a predetermined time period, a restriction on the type of device which may be associated with the user account (e.g., based on type of computing device, based on BIN of the payment device, and the like), a restriction based on a location of the user initiating the device enrollment request as obtained by the social media account, a status of the social media account (e.g., a social media account recently hacked, and the like), and the like. These fraud control rules may be implemented based on all activity associated with the user account or based on activity initiated via a social media account of the user that is associated with the user account.

In response to analyzing the social media data and determining that no potentially fraudulent activity is associated with the device enrollment request, the fraud detection system 12 may generate and communicate the processing request message. The processing request message may be communicated to the user device 22 and/or the social media system 80. The processing request message may cause the social media system 80 to process the device enrollment request to completion.

Processing the device enrollment request to completion may include the social media system 80 communicating with a device enrollment processor 96 operated by or on behalf of the issuer of the user account and/or a transaction service provider associated with the user account. The device enrollment processor 96 may associate the device with the user account, such as by enrolling/registering the device with the user account. The device enrollment processor 96 may communicate to the social media system 80 upon successfully associating the device with the user account, which may be communicated to the user (e.g., user device 22).

In response to analyzing the social media data and determining that potentially fraudulent activity is associated with the device enrollment request, the fraud detection system 12 may generate and communicate the rejection message, which may cause the device enrollment request to be terminated. A fraud alert message may be communicated to the user (e.g., user device 22).

While certain non-limiting embodiments or aspects of systems 10 for detecting fraudulent activity incorporated into one or more systems involving a user account have been described in connection with FIGS. 6-10, it will be appreciated that other systems involving user accounts may incorporate the system 10 for detecting fraudulent activity associated with requests initiated via a social media account.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A method for detecting fraudulent activity, comprising:
generating, with at least one processor, at least one fraud control rule associated with at least one payment account parameter of a payment account;
receiving, with at least one processor, a request message from a user device, wherein the request message comprises social media data associated with a social media account of a user, wherein the social media data comprises unencrypted social media data and encrypted social media data;
analyzing, with at least one processor, the request message for fraudulent activity by analyzing the social media data with respect to the at least one fraud control rule;
automatically generating, with at least one processor, a response message, the response message comprising at least one of: a processing request message associated with the request message in response to the social media data not satisfying the fraud control rule; and a rejection message in response to the social media data satisfying the fraud control rule; and
communicating, with at least one processor, the response message.

2. The method of claim 1, wherein analyzing the social media data with respect to the at least one fraud control rule comprises:
determining that the social media data corresponds to stored social media data;
based on determining that the social media data corresponds to stored social media data, associating the social media data with the payment account; and
determining whether the fraud control rule is satisfied.

3. The method of claim 2, wherein the stored social media data is stored in a transaction service provider database or an issuer database.

4. The method of claim 1, further comprising:
generating, with at least one processor, update data associated with the at least one payment account parameter in response to receiving the request message.

5. The method of claim 4, wherein the at least one fraud control rule comprises a velocity control rule comprising a count and defining a count limit associated with processing request messages associated with the payment account,
wherein generating the update data associated with the at least one payment account parameter in response to receiving the request message comprises incrementing the count.

6. The method of claim 1, wherein the request message comprises at least one of: a payment transaction request message, an account validation inquiry request message, a balance inquiry request message, a fund transfer request message, and a payment device enrollment request message.

7. The method of claim 1, wherein analyzing the social media data with respect to the at least one fraud control rule comprises analyzing the encrypted social media data without decrypting the encrypted social media data.

8. The method of claim 1, wherein the encrypted social media data is homomorphically encrypted.

9. The method of claim 1, wherein the request message comprises a public key.

10. The method of claim 1, further comprising: in response to the social media data satisfying the fraud control rule, generating and communicating, with at least one processor, a fraud alert message.

11. The method of claim 1, wherein the request message does not comprise an account identifier associated with the payment account and assigned by an issuer system.

12. A system for detecting fraudulent activity, comprising at least one processor programmed or configured to:
generate at least one fraud control rule associated with at least one payment account parameter of a payment account;
receive a request message from a user device, wherein the request message comprises social media data associated with a social media account of a user, wherein the social media data comprises unencrypted social media data and encrypted social media data;
analyze the request message for fraudulent activity by analyzing the social media data with respect to the at least one fraud control rule;
automatically generate a response message, the response message comprising at least one of: a processing request message associated with the request message in response to the social media data not satisfying the fraud control rule; and a rejection message in response to the social media data satisfying the fraud control rule; and
communicate the response message.

13. The system of claim 12, wherein analyzing the social media data with respect to the at least one fraud control rule comprises:
determining that the social media data corresponds to stored social media data;
based on determining that the social media data corresponds to stored social media data, associating the social media data with the payment account; and
determining whether the fraud control rule is satisfied.

14. The system of claim 13, wherein the stored social media data is stored in a transaction service provider database or an issuer database.

15. The system of claim 12, wherein the at least one processor is further programmed or configured to:
generate update data associated with the at least one payment account parameter in response to receiving the request message.

16. The system of claim 15, wherein the at least one fraud control rule comprises a velocity control rule comprising a count and defining a count limit associated with processing request messages associated with the payment account,
wherein generating the update data associated with the at least one payment account parameter in response to receiving the request message comprises incrementing the count.

17. The system of claim 12, wherein the request message comprises at least one of: a payment transaction request message, an account validation inquiry request message, a balance inquiry request message, a fund transfer request message, and a payment device enrollment request message.

18. The system of claim 12, wherein analyzing the social media data with respect to the at least one fraud control rule comprises analyzing the encrypted social media data without decrypting the encrypted social media data.

19. The system of claim 12, wherein in response to the social media data satisfying the fraud control rule, the at least one processor is further programmed or configured to generate and communicate a fraud alert message.

20. A computer program product for detecting fraudulent activity, the computer program product comprising at least one non-transitory computer-readable medium including one or more instructions that, when executed by at least one processor, cause the at least one processor to:
generate at least one fraud control rule associated with at least one payment account parameter of a payment account;
receive a request message from a user device, wherein the request message comprises social media data associated with a social media account of a user, wherein the social media data comprises unencrypted social media data and encrypted social media data;
analyze the request message for fraudulent activity by analyzing the social media data with respect to the at least one fraud control rule;
automatically generate a response message, the response message comprising at least one of: a processing request message associated with the request message in response to the social media data not satisfying the fraud control rule; and a rejection message in response to the social media data satisfying the fraud control rule; and
communicate the response message.
